(19) United States
(12) Patent Application Publication
(10) Pub. No.: US 2015/0133101 A1
(43) Pub. Date: May 14, 2015

(54) Terminal and method for activating terminal

(71) Applicant: ZTE Corporation, Shenzhen, Guangdong (CN)

(72) Inventor: Zhenjie Yang, Shenzhen (CN)

(73) Assignee: ZTE CORPORATION, Shenzhen, Guangdong (CN)

(21) Appl. No.: 14/405,032

(22) PCT Filed: Jul. 18, 2013
(86) PCT No.: PCT/CN2013/079630

§ 371 Date: Dec. 2, 2014

(30) Foreign Application Priority Data
Nov. 27, 2012 (CN) 201210489197.0

(51) Int. Cl. H04W 52/02; H04M 1/725

(52) U.S. Cl. CPC H04W 52/0254; H04M 1/7258; H04W 52/027
USPC 455/418

(57) ABSTRACT

Provided are a terminal and a method for activating a terminal to facilitate awakening the terminal by a user in a dark environment. The method for activating a terminal includes: when the terminal is in a dormancy state, it is detected whether a screen triggering signal is received that meets a preset condition; if the screen triggering signal is received that meets the preset condition, a light emitting module arranged near a dormancy awakening key is lighted; an awakening signal generated by pressing the dormancy awakening key by a user is received and the terminal is activated upon receiving the awakening signal. Through implementation of the present disclosure, when a user needs to activate the terminal in a dark environment, he/she only needs to perform on the screen a slide operation or a long-press click operation that meets a condition so that the light emitting module can be lighted, and with the guidance of the light emitting module, the terminal is easily activated through the dormancy awakening key, thus avoiding blind operation and improving user experiences.

### TECHNICAL FIELD

The present disclosure relates to the field of electronic devices, and in particular to a terminal and a method for activating a terminal.

### BACKGROUND

Mobile terminals, such as mobile phones, have already been indispensable devices for people, in order to meet increasingly high requirements on mobile terminals, touch screens of current mobile terminals become increasingly large, thin and thus consume more power. To save power, a current mobile terminal may enter a dormancy state when not being used by a user; in order to avoid a misoperation that may awaken the mobile terminal, the mobile terminal is currently configured with a specified dormancy awakening key, through which a user can awaken a mobile terminal in the dormancy state.

However, as mobile terminals become increasingly thin, the size of a dormancy awakening key becomes increasingly smaller, if a user needs to use a mobile terminal in a dark environment, he/she has to seek blindly for a dormancy awakening key, thus wasting a long time and affecting user experiences.

### SUMMARY

Embodiments of the present disclosure provide a terminal and a method for activating a terminal to facilitate awakening the terminal by a user in a dark environment.

Embodiments of the present disclosure provides a method for activating a terminal, in one embodiment, the method for activating a terminal includes: when the terminal is in a dormancy state, it is detected whether a screen triggering signal is received that meets a preset condition; if the screen triggering signal is received that meets the preset condition, a light emitting module arranged near a dormancy awakening key is lighted; an awakening signal generated by pressing the dormancy awakening key by a user is received and the terminal is activated upon receiving the awakening signal.

In an embodiment, the step of detecting whether a screen triggering signal is received that meets a preset condition may include: it is detected whether a screen triggering signal is received; if the screen triggering signal is received, it is determined whether the screen triggering signal meets the preset condition; if the screen triggering signal meets the preset condition, proceed to the step of lighting the light emitting module arranged near the dormancy awakening key.

In an embodiment, the preset condition may include: a screen triggering signal received upon the user performs a slide operation on a screen of the terminal; or a screen triggering signal received upon the user performs a long-press click operation on the screen of the terminal.

In an embodiment, after the lighting a light emitting module arranged near a dormancy awakening key and before the receiving an awakening signal generated by pressing the dormancy awakening key by a user, the method may further include: it is detected whether the awakening signal transmitted by the dormancy awakening key is received within a preset period; if the awakening signal is not received within the preset period, the light emitting module is extinguished.

In addition, embodiments of the present disclosure further provide a terminal which applies the method for activating a terminal provided by above embodiments, and the terminal includes a detection module, a light emitting module, a dormancy awakening key and an awakening module connected successively, wherein

the detection module is configured to, when the terminal is in a dormancy state, detect whether a screen triggering signal is received that meets a preset condition; and when the screen triggering signal is received that meets the preset condition, light the light emitting module;

the light emitting module is arranged near the dormancy awakening key and configured to be lighted under the control of the detection module;

the dormancy awakening key is configured to transmit an awakening signal to the awakening module when the dormancy awakening key is pressed by a user; and

the awakening module is configured to awaken a terminal where it is located upon receiving the awakening signal transmitted by the dormancy awakening key.

In an embodiment, the detection module may include a reception submodule and a determination submodule, wherein

the reception submodule is configured to detect whether a screen triggering signal is received, and if the screen triggering signal is received, transmit a received screen triggering signal to the determination submodule;

the determination submodule is configured to determine whether the screen triggering signal transmitted by the reception submodule meets the preset condition; and if the preset condition is met, light the light emitting module.

In an embodiment, the detection module is further configured to determine whether the awakening module receives the awakening signal within a preset period after the light emitting module is lighted; and if the awakening module does not receive the awakening signal within the preset period, extinguish the light emitting module;

accordingly, the light emitting module is further configured to be extinguished under the control of the detection module.

In an embodiment, the dormancy awakening key is a touch key on a screen or a physical key beyond the screen.

In an embodiment, the dormancy awakening key is a power-on key of the terminal.

In an embodiment, the light emitting module is an indicating lamp arranged near the dormancy awakening key.

Through implementation of the present disclosure, a light emitting module is added near a dormancy awakening key of a terminal, when a user needs to activate the terminal in a dark environment, he/she only needs to perform on the screen a slide operation or a long-press click operation that meets a condition so that the light emitting module can be lighted, and with the guidance of the light emitting module, the terminal is easily activated through the dormancy awakening key, thus avoiding blind operation and improving user experiences.

### BRIEF DESCRIPTION OF THE DRAWINGS

FIG. 1 is a schematic diagram of a terminal provided by an embodiment of the present disclosure;

FIG. 2 is a schematic diagram of a detection module in FIG. 1;

FIG. 3 is a schematic diagram of a method for activating a terminal provided by an embodiment of the present disclosure;

FIG. 4 is a schematic diagram of a terminal provided by a preferred embodiment of the present disclosure; and

FIG. 5 is a schematic diagram of a method for activating a terminal provided by a preferred embodiment of the present disclosure.

### DETAILED DESCRIPTION

Embodiments of the present disclosure provide a terminal and a method for activating a terminal in which by lighting a light emitting indicating lamp arranged near a dormancy awakening key of the terminal through performing a touch operation and thus the terminal is activated with the guidance of the light emitting indicating lamp, thereby solving a problem that a user desired to activate a terminal in a dark environment has to seek blindly for a dormancy awakening key. The present disclosure will be further elaborated below through specific embodiments in combination with accompanying drawings.

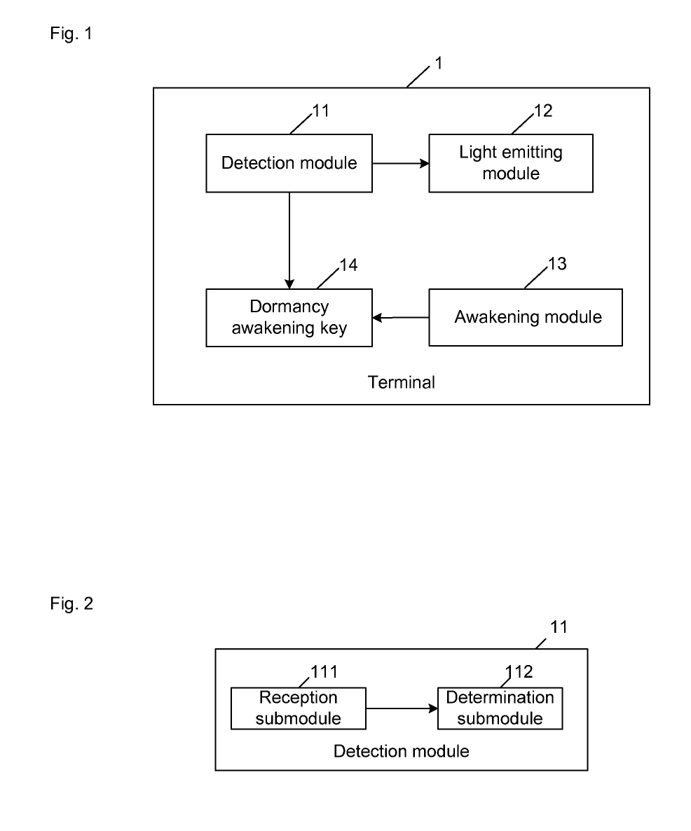

FIG. 1 is a schematic diagram of a terminal provided by an embodiment of the present disclosure; it can be seen from FIG. 1 that in the embodiment, the terminal 1 provided by the present disclosure includes a detection module 11, a light emitting module 12, a dormancy awakening key 13 and an awakening module 14 connected successively, wherein

the detection module 11 is configured to, when the terminal is in a dormancy state, detect in real time or periodically whether a screen triggering signal is received that meets a preset condition; and when the screen triggering signal is received that meets the preset condition, light the light emitting module 12, e.g., transmit a lighting signal to the light emitting module 12;

the light emitting module 12 is arranged near the dormancy awakening key 13 and configured to be lighted under the control of the detection module 13, for example, after the lighting signal of the detection module 11 is received, light itself and indicate the position of the dormancy awakening key 13.

the dormancy awakening key 13 is configured to transmit an awakening signal to the awakening module 14 when being pressed by a user; and

the awakening module 14 is configured to awaken the terminal 1 where it is located upon receiving the awakening signal transmitted by the dormancy awakening key 13.

FIG. 2 is a schematic diagram of the detection module 11 in FIG. 11; as shown in FIG. 2, in order to whether a screen triggering signal is received that meets a preset condition, in the embodiment, the detection module 11 includes a reception submodule 111 and a determination submodule 112, wherein

the reception submodule 111 is configured to, if it is detected that the screen triggering signal is received, transmit a received screen triggering signal to the determination submodule 112, for example, receive in real time or periodically the screen triggering signal and transmit a received screen triggering signal to the determination submodule 112;

the determination submodule 112 is configured to, if it is determined that the screen triggering signal transmitted by the reception submodule 111 meets the preset condition, light the light emitting module 112, for example transmit a lighting signal to the light emitting module 12.

Further, the screen triggering signal that meets the preset condition in above embodiments may include: a screen triggering signal received upon the user performs a slide operation on a screen of the terminal; or a screen triggering signal received upon the user performs a long-press click operation on the screen of the terminal.

Further, in order to avoid a misoperation and thus save electrical energy, the detection module 11 in the above embodiments is configured to, after the light emitting module 12 is lighted, if it is detected that the awakening module 14 does not receive the awakening signal within a preset period, extinguish the light emitting module 12; accordingly, the light emitting module 12 is configured to be extinguished under the control of the detection module 11.

Specifically, the detection module 11 can be configured to detect whether the awakening module 14 receives an awakening signal within a preset period after a lighting instruction is transmitted, and transmit an extinguishing signal to the light emitting module 12 if the awakening module 14 does not receive the awakening signal within the preset period; accordingly, the light emitting module 12 goes out upon receiving the extinguishing signal.

In the embodiment, the awakening module 14 is configured to, when the awakening signal is not received within the preset period, represent that a user is not currently desirable to activate the terminal, that is to say, a received screen triggering signal that meets the preset condition is a misoperation by the user, then the light emitting module 12 is extinguished so as to avoid a waste of electrical energy.

Further, the dormancy awakening key 13 in the above embodiments is a touch key on a screen or a physical key beyond the screen.

Further, the dormancy awakening key 13 in the above embodiments is a power-on key of the terminal.

Further, the light emitting module 12 in the above embodiments is an indicating lamp arranged near the dormancy awakening key 13.

Further, the detection module 11 in the above embodiments is a Programmable Logic Controller (PLC) or other types of microcontroller.

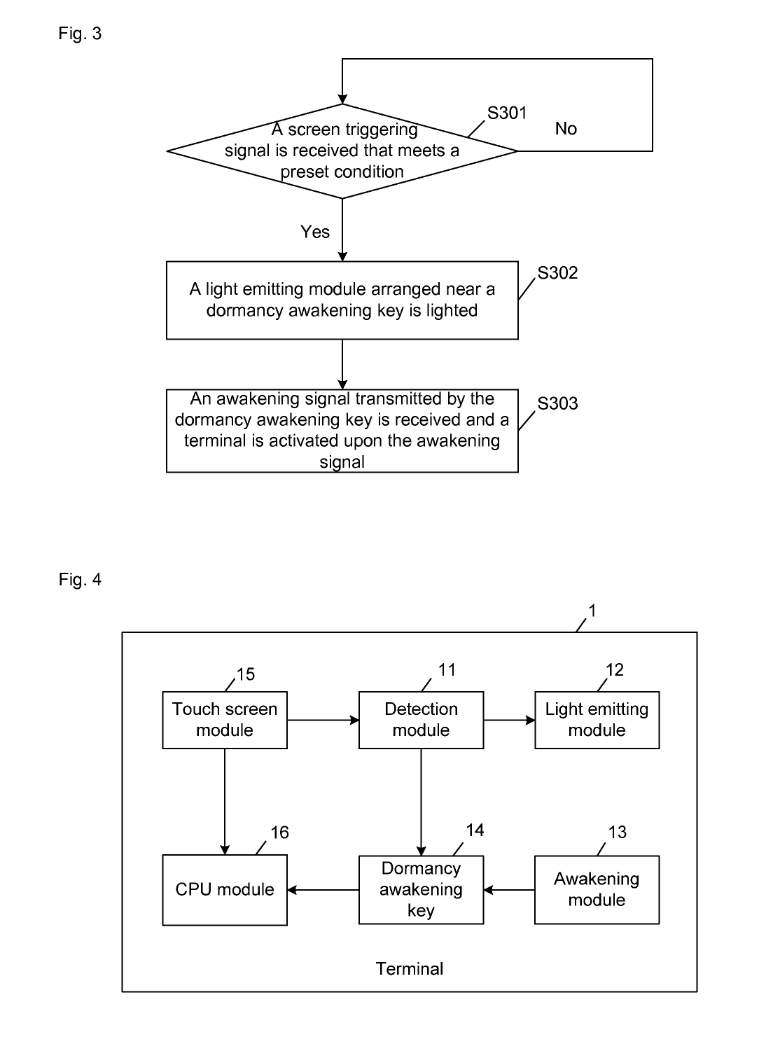

In addition, embodiments of the present disclosure also provides a method for activating a terminal, which will be now described with reference to FIG. 3; FIG. 3 is a schematic diagram of a method for activating a terminal provided by an embodiment of the present disclosure, as shown in FIG. 3, in the embodiment, the method for activating a terminal provided by the embodiment includes the following steps:

step S301, when a terminal is in a dormancy state, it is detected in real time whether a screen triggering signal is received that meets a preset condition; if the screen triggering signal is received that meets the preset condition, proceed to step S302; otherwise, proceed to step S301.

In an embodiment, the detecting whether a screen triggering signal is received that meets a preset condition may specifically include:

it is detected whether a screen triggering signal is received;

if the screen triggering signal is received, determining whether the screen triggering signal meets the preset condition;

if the preset condition is met, proceed to S302, otherwise, continue implementing step S301.

Further, the signal that meets the preset condition may include: a screen triggering signal received upon the user performs a slide operation on a screen of the terminal; or a screen triggering signal received upon the user performs a long-press click operation on the screen of the terminal.

Step S302, a light emitting module arranged near a dormancy awakening key is lighted;

In an embodiment, after the light emitting module arranged near the dormancy awakening key is lighted, the method for activating a terminal provided by the embodiment of the present disclosure may further include:

it is detected whether an awakening signal transmitted by the dormancy awakening key is received within a preset period; if the awakening signal is not received within the preset period, the light emitting module is extinguished; if it is received, proceed to step S303.

Step S303, the awakening signal transmitted by the dormancy awakening key is received and the terminal is activated upon receiving the awakening signal.

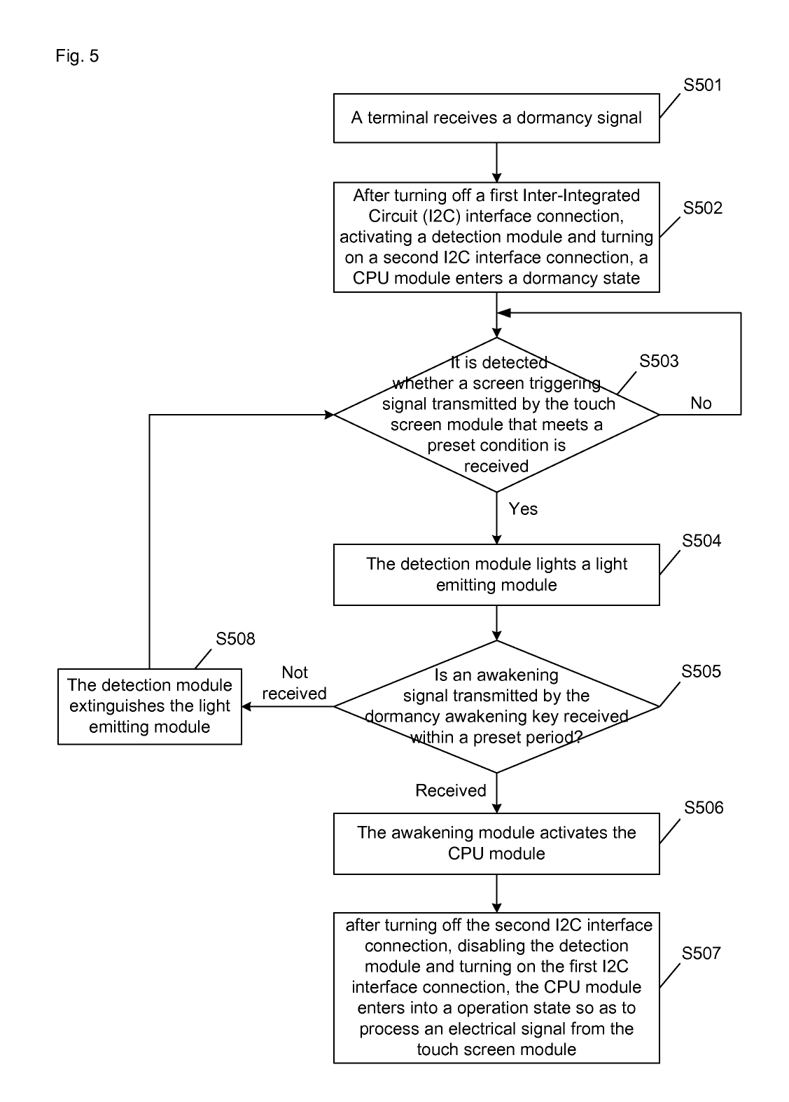

In order to further explain spirits of embodiments of the present disclosure, application scenarios of embodiments of the present disclosure will be elaborated with reference to FIG. 4 and FIG. 5.

FIG. 4 is a schematic diagram of a terminal provided by a preferred embodiment of the present disclosure; it can be known from FIG. 4 that in practical applications, besides the detection module 11, the light emitting module 12, the dormancy awakening key 13 and the awakening module 14 connected successively as described in above embodiments, the terminal 1 further includes a touch screen module 15 for implementing the conversion of a touch operation on a touch screen by the user to a electrical signal as well as a CPU module 16 for implementing data and signal processing functions.

Wherein specific functions of the touch screen module 15 and the CPU module 16 are not key points of the present disclosure, thus detailed descriptions thereof will be omitted.

The connection relationship of respective functional modules above is as shown in FIG. 4, the CPU module 16 and the touch screen module 15 are connected via an I2C interface, in order to simplify explanation thereafter, it is noted as a first I2C interface; the detection module 11 and the touch screen module 15 are also connected via an I2C interface, in order to simplify explanation thereafter, it is noted as a second I2C interface.

FIG. 5 is a schematic diagram of a method for activating a terminal provided by a preferred embodiment of the present disclosure; as shown in FIG. 5, in practical applications, the method for activating a terminal provided by embodiments of the present disclosure includes the following steps:

Step S501, terminal 1 receives a dormancy signal.

Wherein the method for receiving a dormancy signal will be omitted.

Step S502, after turning off a first Inter-Integrated Circuit (I2C) interface connection, activating a detection module 11 and turning on a second I2C interface connection, a CPU module 16 enters a dormancy state.

Step S503, the detection module 11 detects in real time whether a screen triggering signal transmitted by the touch screen module 15 that meets a preset condition is received, when it is received, proceed to step S504, otherwise, continue implementing step S503.

Step S504, the detection module 11 lights a light emitting module 12.

Step S505, the detection module 11 detects whether an awakening signal transmitted by the dormancy awakening key 13 is received by an awakening module 14 within a preset period; if the awakening signal is not received, proceed to step S503; if it is received, proceed to step S506.

Step S506, the awakening module 14 activates the CPU module 16.

Step S507, after turning off the second I2C interface connection, disabling the detection module 11 and turning on the first I2C interface connection, the CPU module 16 enters into a operation state so as to process an electrical signal from the touch screen module 15, and then the processing process ends.

Step S508, the detection module 11 extinguishes the light emitting module 12, then returns to step S503.

It can known from above description that the embodiments of the present disclosure at least have the following beneficial effects:

a light emitting module arranged near a dormancy awakening key can be lighted by performing by a user a simple operation on a touch screen when a terminal is in a dormancy state, thus the dormancy awakening key can be used to conveniently awaken the terminal.

Further, the terminal automatically detects whether an awakening signal is received within a preset period, if the awakening signal is not received, it is determined that it is a misoperation, then the light emitting module is extinguished so as to avoid a waste of electrical energy caused by the misoperation of the user.

The above are merely specific embodiments of the present disclosure, and are not intended to limit the present disclosure. Any simple changes, equivalent variations or modifications of the above embodiments based on the technical essence thereof all belong to the scope of protection of the technical solutions of the embodiments of the present disclosure.

1. A method for activating a terminal, comprising:
detecting whether a screen triggering signal is received that meets a preset condition when the terminal is in a dormancy state;
lighting a light emitting module arranged near a dormancy awakening key when the screen triggering signal is received;
receiving an awakening signal generated by pressing the dormancy awakening key by a user, and activating the terminal upon receiving the awakening signal.

2. The method according to claim 1, wherein the step of detecting whether a screen triggering signal is received that meets a preset condition includes:
detecting whether a screen triggering signal is received;
determining whether the screen triggering signal meets the preset condition when the screen triggering signal is received,;
lighting the light emitting module arranged near the dormancy awakening key when the screen triggering signal meets the preset condition.

3. The method according to claim 2, wherein the preset condition comprises:
a screen triggering signal received upon the user performs a slide operation on a screen of the terminal;
or a screen triggering signal received upon the user performs a long-press click operation on the screen of the terminal.

4. The method according to claim 1, after the step of lighting a light emitting module arranged near a dormancy awakening key and before the step of receiving an awakening signal generated by pressing the dormancy awakening key by a user, the method further comprising:
detecting whether the awakening signal is received within a preset period;
extinguishing the light emitting module when the awakening signal is not received within the preset period.

5. A terminal comprising a detection module, a light emitting module, a dormancy awakening key and an awakening module connected successively, wherein
the detection module is configured to, when the terminal is in a dormancy state, detect whether a screen triggering signal is received that meets a preset condition, and light the light emitting module when the screen triggering signal is received that meets the preset condition;
the light emitting module is arranged near the dormancy awakening key and configured to be lighted under the control of the detection module;
the dormancy awakening key is configured to transmit an awakening signal to the awakening module when the dormancy awakening key is pressed by a user; and
the awakening module is configured to awaken the terminal upon receiving the awakening signal transmitted by the dormancy awakening key.

6. The terminal according to claim 5, wherein the detection module comprises a reception submodule and a determination submodule, wherein
the reception submodule is configured to detect whether a screen triggering signal is received, and transmit a received screen triggering signal to the determination submodule when the screen triggering signal is received;
the determination submodule is configured to determine whether the screen triggering signal transmitted by the reception submodule meets the preset condition, and light the light emitting module when the preset condition is met.

7. The terminal according to claim 5, wherein
the detection module is further configured to, after the light emitting module is lighted, determine whether the awakening module receives the awakening signal within a preset period, and extinguish the light emitting module when the awakening module does not receive the awakening signal within the preset period.
the light emitting module is further configured to be extinguished under the control of the detection module.

8. The terminal according to claim 5, wherein the dormancy awakening key is a touch key on a screen or a physical key beyond the screen.

9. The terminal according to claim 8, wherein the dormancy awakening key is a power-on key of the terminal.

10. The terminal according to claim 5, wherein the light emitting module is an indicating lamp arranged near the dormancy awakening key.

11. The method according to claim 2, after the step of lighting a light emitting module arranged near a dormancy awakening key and before the step of receiving an awakening signal generated by pressing the dormancy awakening key by a user, the method further comprising:
detecting whether the awakening signal is received within a preset period;
extinguishing the light emitting module when the awakening signal is not received within the preset period.

12. The method according to claim 3, after the step of lighting a light emitting module arranged near a dormancy awakening key and before the step of receiving an awakening signal generated by pressing the dormancy awakening key by a user, the method further comprising:
detecting whether the awakening signal is received within a preset period;
extinguishing the light emitting module when the awakening signal is not received within the preset period.

13. The terminal according to claim 6, wherein the dormancy awakening key is a touch key on a screen or a physical key beyond the screen.

14. The terminal according to claim 7, wherein the dormancy awakening key is a touch key on a screen or a physical key beyond the screen.

15. The terminal according to claim 6, wherein the light emitting module is an indicating lamp arranged near the dormancy awakening key.

16. The terminal according to claim 7, wherein the light emitting module is an indicating lamp arranged near the dormancy awakening key.
